(19) United States
(12) Patent Application Publication
(10) Pub. No.: US 2023/0094938 A1
(43) Pub. Date: Mar. 30, 2023

(54) TOUCH FEEDBACK DEVICE AND ELECTRONIC DEVICE

(71) Applicant: AAC Acousitc Technologies (Shanghai)Co., Ltd., Shanghai (CN)

(72) Inventors: Lijin Zhang, Shenzhen (CN); Yongyong Chen, Shenzhen (CN); Bing Xie, Shenzhen (CN)

(21) Appl. No.: 17/944,212

(22) Filed: Sep. 14, 2022

(30) Foreign Application Priority Data
Sep. 24, 2021 (CN) 202122314060.9

(51) Int. Cl. G06F 3/01; G06F 3/041

(52) U.S. Cl. CPC G06F 3/016; G06F 3/041; G06F 2203/04104

(57) ABSTRACT

A touch feedback device and an electronic device are provided. The touch feedback device includes a touch panel; a linear vibration motor arranged on the touch panel and being able to drive the touch panel to vibrate; a mounting member; and a mounting base. The mounting member includes at least one fixing part and a body that is elastic. The touch panel is fixed to the body, and the at least one fixing part is configured to fix the body to the mounting base, in such a manner the touch panel is limited to vibrate along any direction in a horizontal direction. The natural frequency of the touch feedback device can be effectively regulated, and the linear vibration motor at any position on the touch panel does not have much effect on the vibration distribution of the touch panel, thereby improving the vibration touch of the touch feedback device.

### TECHNICAL FIELD

The present invention relates to the technical field of touch feedback, and in particular, to a touch feedback device and an electronic device.

### BACKGROUND

Electronic device manufacturers, especially portable electronic device manufacturers, are always trying to improve the user experience. Movement feedback (such as active force feedback and resistance feedback) and haptic feedback (such as vibration, thermal energy), are both referred to as “haptic feedback”, which can provide users with a stronger experience. Specifically, haptic effects, such as vibration effects and vibration haptic effects, provide realistic feedback to generate sensory sensations within a simulated or virtual environment.

Haptic feedback is being incorporated into devices such as mobile phones or personal digital assistants (PDAs), and a difference different from the mobile phone touch feedback solutions is the application of linear vibration motors in notebook computer and automotive module feedback solutions. In order to obtain a satisfactory vibration touch, the selection of a suspension structure between the touch panel and the whole machine is particularly important.

In the related art, the suspension structure is generally made of silica gel. Since silica gel is not a linear material and greatly affected by temperature, and at the same time, has a relatively high degree of plane freedom, a position of the linear vibration motor on the touch panel will also affect the acceleration distribution on the surface of the touch panel.

Therefore, it needs to provide a touch feedback device and an electronic device to solve the above problems.

### SUMMARY

An embodiment of the present invention provides a touch feedback device, including a touch panel; a linear vibration motor arranged on the touch panel and being able to drive the touch panel to vibrate; a mounting member; and a mounting base. The mounting member includes at least one fixing part and a body that is elastic. The touch panel is fixed to the body, and the at least one fixing part is configured to fix the body to the mounting base, in such a manner the touch panel is limited to vibrate along any direction in a horizontal direction.

As an improvement, the mounting member further includes at least one side wall connected to a side of the body, and the at least one fixing part is arranged at a side of the side wall away from the body.

As an improvement, the mounting member further includes at least one cross arm, the at least one cross arm is disposed at a side wall of the body, and the side wall is connected to the body through the at least one cross arm.

As an improvement, the touch feedback device further includes a double-side adhesive layer, the touch panel is fixed to at least one of the body or the at least one cross arm through the double-side adhesive layer.

As an improvement, the double-side adhesive layer includes a primary adhesive part, the primary adhesive part has a shape fitting a shape of the body in such a manner that the touch panel is fixed to the body through the primary adhesive part.

As an improvement, the double-side adhesive layer further includes at least one secondary adhesive part, the at least one secondary adhesive part is arranged at a side of the primary adhesive part, and the secondary adhesive part has a shape fitting a shape of the at least one cross arm in such a manner that the touch panel is fixed to the at least one cross arm through the secondary adhesive part.

As an improvement, the at least one cross arm includes a plurality of the cross arms, and the plurality of cross arms is arranged at intervals along a length direction of the side wall.

As an improvement, the at least one side wall includes two side walls respectively arranged at two opposite ends of the body, each of the two side walls is connected to a side of the body away from the touch panel, and each of the two side walls is provided with the at least one fixing part.

As an improvement, the body, the at least one side wall, and the at least one cross arm are all made of stainless steel.

Another embodiment of the present invention provides an electronic device, including a touch feedback device, including a touch panel; a linear vibration motor arranged on the touch panel and being able to drive the touch panel to vibrate; a mounting member; and a mounting base. The mounting member includes at least one fixing part and a body that is elastic. The touch panel is fixed to the body, and the at least one fixing part is configured to fix the body to the mounting base, in such a manner the touch panel is limited to vibrate along any direction in a horizontal direction.

### BRIEF DESCRIPTION OF DRAWINGS

FIG. 1 is a perspective view of a touch feedback device provided by some embodiments of the present invention;

FIG. 2 is an exploded view of the touch feedback device shown in FIG. 1;

FIG. 3 is a perspective view of a mounting member shown in FIG. 2;

FIG. 4 is a schematic diagram of an amplitude range of a touch panel in a touch feedback device provided by some embodiments of the present invention;

FIG. 5A is a schematic diagram illustrating an offset of a touch panel when center position on the touch panel is pressed in a touch feedback device provided by some embodiments of the present invention.

FIG. 5B is a schematic diagram illustrating an offset of a touch panel when upper position on the touch panel is pressed in a touch feedback device provided by some embodiments of the present invention.

FIG. 5C is a schematic diagram illustrating an offset of a touch panel when left position on the touch panel is pressed in a touch feedback device provided by some embodiments of the present invention.

FIG. 5D is a schematic diagram illustrating an offset of a touch panel when upper left position on the touch panel is pressed in a touch feedback device provided by some embodiments of the present invention.

FIG. 5E is a table illustrating statistics of the displacements of a touch panel when the above positions in FIGS. 5A-5D on the touch panel are pressed.

FIG. 6F is a schematic diagram illustrating a distribution of the vibration amount of a touch panel when a linear vibration motor is assembled at a lower side position on the touch panel.

FIG. 6G is a schematic diagram illustrating a distribution of the vibration amount of a touch panel when a linear vibration motor is assembled at a left side position on the touch panel.

### REFERENCE NUMERALS

100. Touch feedback device;

1. Mounting member;

11. Body;

111. Lightening hole;

12. Fixing part;

13. Side wall;

14. Cross arm;

2. Touch panel;

3. Mounting base;

4. Double-sided adhesive layer;

41. Primary adhesive part;

42. Secondary adhesive part.

### DESCRIPTION OF EMBODIMENTS

The present invention will be described below with reference to the accompanying drawings and embodiments.

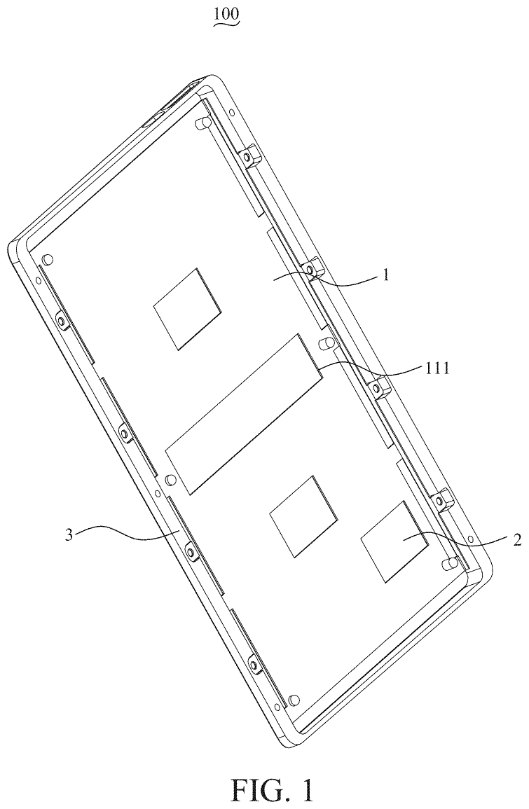

Some embodiments of the present invention provide a touch feedback device 100. As shown in FIG. 1 to FIG. 3, the touch feedback device 100 includes a mounting member 1, a touch panel 2, a linear vibration motor (not shown in the figure), and a mounting base 3. The linear vibration motor can be arranged on the touch panel 2, for example, arranged at a side of the touch panel 2 with a screen. The linear vibration motor can drive the touch panel 2 to vibrate, that is, when pressing the touch panel 2, the linear vibration motor provides a vibration feedback. The mounting member 1 includes an elastic body 11 and at least one fixing part 12. The touch panel 2 can be fixed to the body 11, and the side of the touch panel 2 with the screen faces away from the body 11. The body 11 can be an elastic sheet. The body can have different shapes or thicknesses, and then the natural frequency of the touch feedback device 100 can be effectively regulated through simulation. The fixing part 12 can be configured to fix the mounting member 1 onto the mounting base 3 to limit the touch panel 2 to vibrate with a displacement along any direction in a horizontal direction. When the mounting member 1 is assembled to the mounting base 3, the fixing part 12of the mounting member 1 can overlap on the mounting base 3, and then a fastener (not shown in the figure) passes through the fixing part 12 and the mounting base 3, so that the body 11 of the mounting member 1 is fixed to the mounting base 3, that is, the touch panel 2 is supported on the mounting base 3.

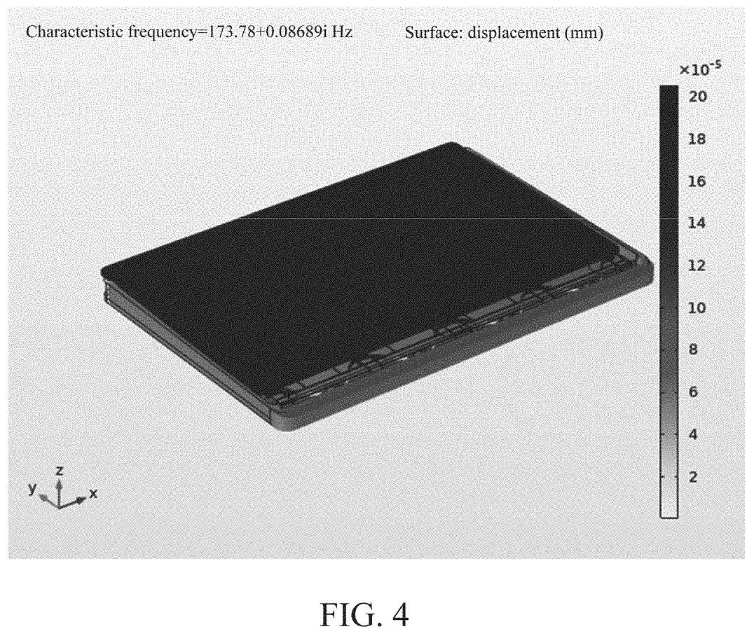

In order to better illustrate the spatial positional relationship and the motion relationship of each component/member, a three-dimensional spatial coordinate system XYZ is taken as a reference for the description below. As shown in FIG. 4, a horizontal direction described herein is set as the XoY plane in the three-dimensional spatial coordinate system XYZ, a length direction of the body 11 of the mounting member 1 is set as the X-axis direction in the three-dimensional spatial coordinate system XYZ, and a width direction of the body 11 is set as the Y-axis direction in the three-dimensional space coordinate system XYZ, and a thickness direction of the body 11 is set as the Z-axis direction in the three-dimensional spatial coordinate system XYZ. Based on the above, the touch panel 2 and the side wall 13 of the mounting member 1 can be located at two ends of the body 11 of the mounting member 1 in the Z-axis direction, respectively. When setting the displacement of the body 11 in the Y-axis direction when the body 11 vibrates, the cross arm 14 can be arranged at one end of the body 11 in the Y-axis direction to limit the displacement of the touch panel 2 in the Y-axis direction, that is, effectively reducing the degree of freedom of the touch panel 2 on the XoY plane when the touch panel 2 vibrates.

To sum up, compared with the related art, the touch feedback device 100 at least has the following beneficial effects.

The touch feedback device 100 takes the mounting member 1 as the suspension structure for supporting the touch panel 2. In this way, the body 11 of the mounting member 1 can have different shapes or thicknesses, and then the natural frequency of the touch feedback device can be effectively regulated through simulation. Meanwhile, the mounting member 1 is fixed to the mounting base 3, thereby limiting the touch panel 2 to vibrate along any direction in the horizontal direction, that is, effectively reducing the degree of freedom of the touch panel 2 in the horizontal direction when the touch panel vibrates, so that the linear vibration motor can be assembled at any position on the touch panel 2. In other words, assembling of the linear vibration motor at any position on the touch panel 2 does not have much effect on the distribution of the vibration amount of the touch panel 2, thereby effectively improving the vibration touch of the touch feedback device 100.

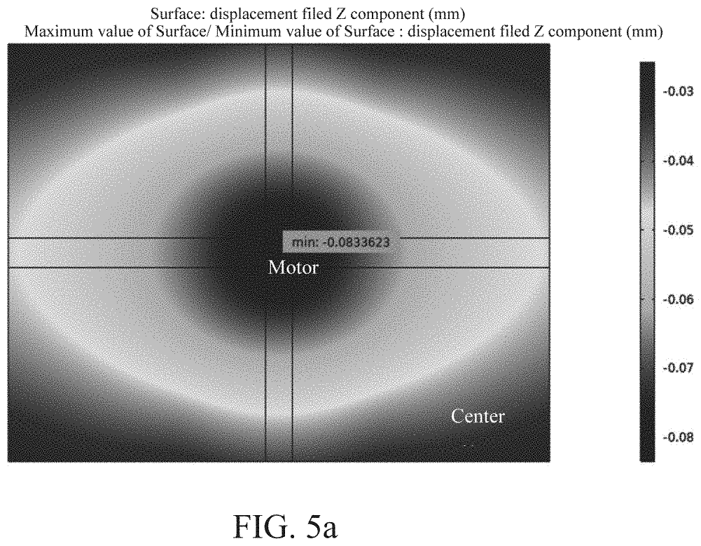

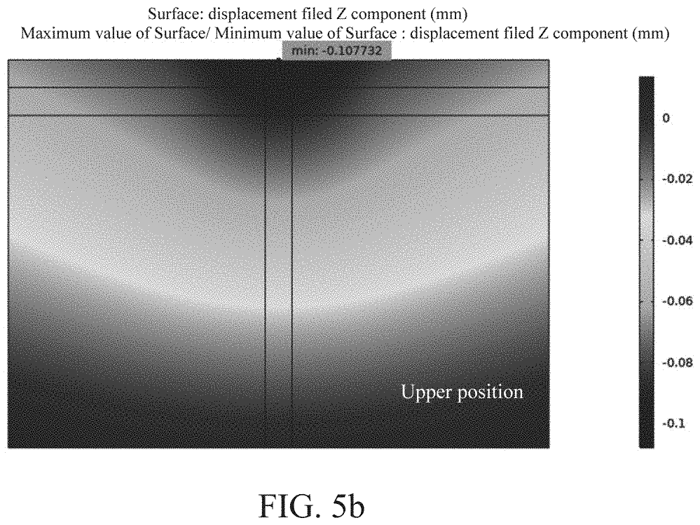

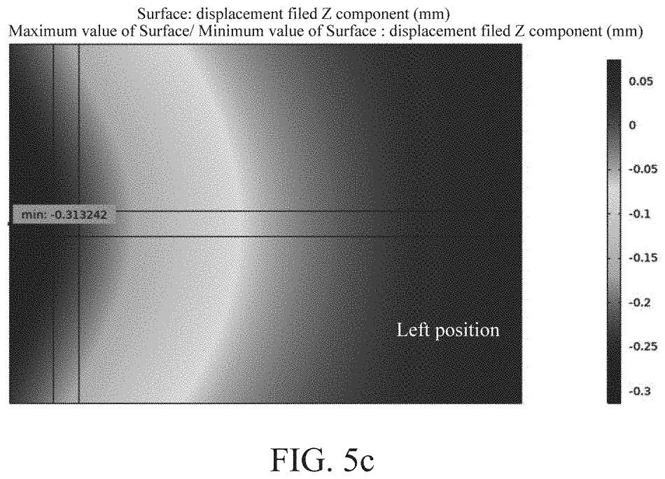

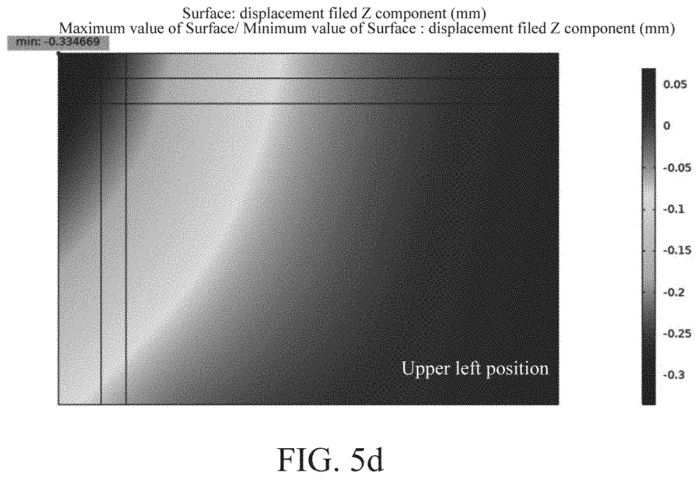

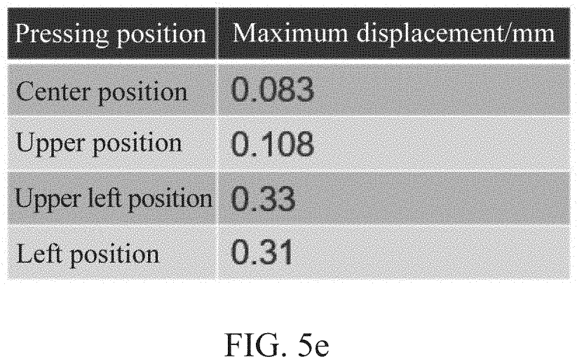

In some embodiments, FIG. 5A represents a displacement of the touch panel 2 on the Z-axis when a center position on the touch panel 2 is pressed, FIG. 5B represents a displacement of the touch panel 2 on the Z-axis when an upper position on the touch panel 2 is pressed, FIG. 5C represents a displacement of the touch panel 2 on the Z-axis when a left position on the touch panel 2 is pressed, FIG. 5D represents a displacement of the touch panel 2 on the Z-axis when an upper left position on the touch panel 2 is pressed, FIG. 5E illustrates statistics of the displacements of the touch panel 2 on the Z axis under the above conditions, and the statistics are respectively as follows: the displacement of the touch panel 2 shown in FIG. 5A is 0.083/mm, the displacement of the touch panel 2 shown in FIG. 5B is 0.108/mm, the displacement of the touch panel 2 shown in FIG. 5C is 0.033/mm, and the displacement of the touch panel 2 shown in FIG. 5D is 0.031/mm. It can be seen from the above that the body 11 of the mounting member 1 has a certain and uniform supporting capacity, so that the touch panel 2 will not be significantly collapsed when any position on the touch panel 2 is pressed.

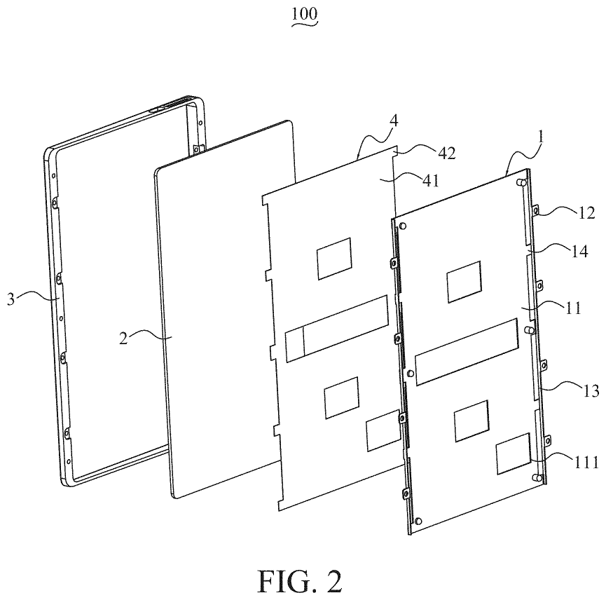

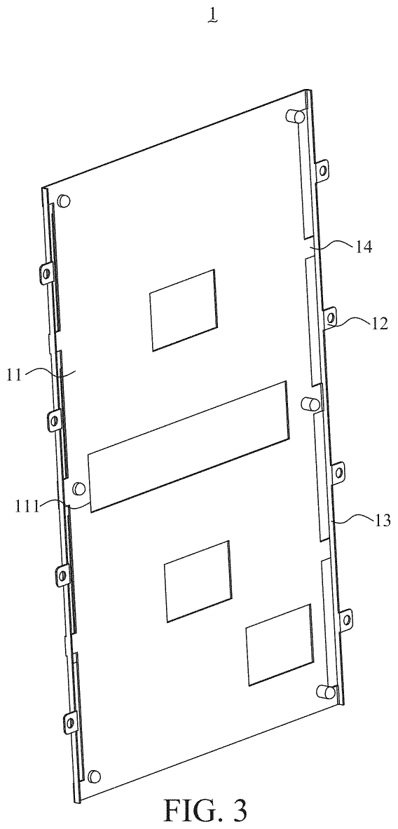

In some embodiments, as shown in FIG. 2 and FIG. 3, the mounting member 1 further includes at least one side wall 13. The touch panel 2 may be located at a side of the body 11, and the side wall 13 may be located of another side of the body 11. The side wall 13 can be connected to a side edge of the body 11. The fixing part 12 may be arranged at a side of the side wall 13 away from the body 11, so that the body 11 can be limited to vibrate with a displacement along a thickness direction of the side wall 13 to avoid deformation of the side wall 13.

In some embodiments, as shown in FIG. 2 and FIG. 3, the mounting member 1 further includes at least one cross arm 14. The cross arm 14 can be provided at a side edge of the body 11, and the side wall 13 can be connected to the body through the cross arm 14.

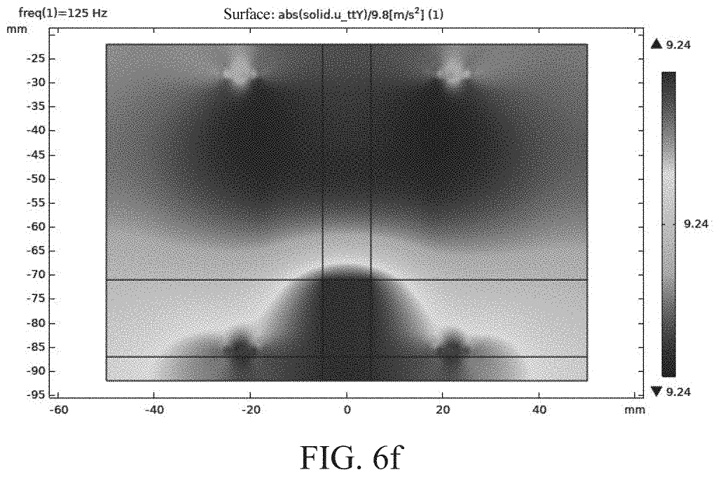

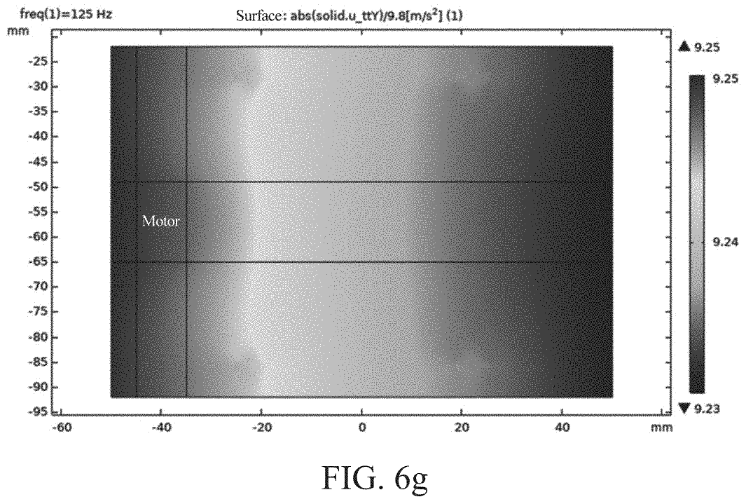

It can be understood that, since one side edge of the body 11 is connected to the fixing part 12 through the side wall 13 and the cross arm 14, in some embodiments, one side edge of the body 11 in the Y-axis direction is connected to the fixing part 12 through the side wall 13 and the cross arm 14. When the body 11 vibrates, the cross arm 14 will pull the side wall 13 to deform in the thickness direction of the side wall 13, i.e., in the Y-axis direction, so that the body 11 moves in this direction to limit the touch panel 2, which is fixed to the body 11, to move along the thickness direction of the side wall 13, i.e., along the Y-axis direction. In this way, the linear vibration motor can be assembled at any position on the touch panel 2, in other words, the linear vibration motor being assembled at any position on the touch panel 2 has little effect on the distribution of the vibration amount of the touch panel 2, thereby effectively improving the vibration touch of the touch feedback device 100., FIG. 6F represents a distribution of the vibration amount of the touch panel 2 when the linear vibration motor is assembled at a lower side position on the touch panel 2, and FIG. 6G represents a distribution of the vibration amount of the touch panel 2 when the linear vibration motor is assembled at a left side position on the touch panel 2. It can be seen from the above that the linear vibration motor being assembled at any position on the touch panel 2 has little effect on the distribution of the vibration amount of the touch panel 2.

In some embodiments, as shown in FIG. 2 and FIG. 3, there can be multiple cross arms 14, and the multiple cross arms 14 can be arranged at intervals along the length direction of the side wall 13, so that each position on the side wall 13 can be uniformly deformed when the side wall 13 is pulled.

In some embodiments, as shown in FIG. 2 and FIG. 3, the fixing part 12 and the cross arm 14 can be staggered along the length direction of the side wall 13.

In some embodiments, as shown in FIG. 2 and FIG. 3, there are two side walls 13, and the two side walls 13 can be respectively provided at two opposite ends of the body 11.

The side wall 13 can be connected to a side of the touch panel 2 away from the body 11. Each side wall 13 can be provided with a fixing part 12.

In some embodiments, as shown in FIG. 2 and FIG. 3, there are two side walls 13, and the two side walls 13 are provided at two ends of the body 11 in the Y-axis direction. Each side wall 13 is provided with multiple fixing parts 12. The fixing parts 12 are arranged at intervals along the X-axis direction to improve the stability of the body 11 when the body 11 is assembled to the mounting base 3. The number of the fixing parts 12 at one of the two side walls 13 is the same as the number of the fixing parts 12 at the other one of the two side walls 13. Each of two ends of the body 11 in the Y-axis direction is provided with multiple cross arms 14. The cross arms 14 at each end are arranged at intervals along the X-axis direction. The number of the cross arms 14 at one of the two ends is the same as the number of the cross arms 14 at the other one of the two ends. Meanwhile, the fixing parts 12 and the cross arms 14 that are connected to a same side wall 13 are staggered along the X-axis direction.

In some embodiments, the body 11 of the mounting member 1 can be configured according to the shape of the touch panel 2. For example, the body 11 has a shape of rectangle or circle, or an irregular shape.

In some embodiments, as shown in FIG. 1 and FIG. 2, the touch feedback device 100 further includes a double-side adhesive layer, and the touch panel 2 can be fixed to the body 11 and/or the cross arm 14 through the double-side adhesive layer 4. The double-side adhesive layer 4 has a thin and uniform thickness, which does not affect the natural frequency of the touch feedback device 100 too much, and does not increase the thickness of the touch feedback device 100.

In some embodiments, as shown in FIG. 3, the double-side adhesive layer 4 includes a main adhesive part 41, and the main adhesive part 41 has a shape fitting the shape of the body 11, so that the touch panel 2 can be fixed to the body 11.

In some embodiments, as shown in FIG. 3, the double-side adhesive layer 4 further includes at least one secondary adhesive part 42, the secondary adhesive part 42 can be disposed at a side edge of the main adhesive part 41, and the secondary adhesive part 42 can have a shape fitting a shape of the touch panel 14, so that the touch panel 2 can be fixed to the cross arm 14.

It can be understood that the shape of the main adhesive part 41 fits the shape of the body 11, and the shape of the auxiliary adhesive part 42 fits the shape of the cross arm 14, so that a uniform force can be applied to each position on the touch panel 2 in contact with the mounting member 1, thereby ensuring that any position where the linear vibration motor is assembled to the touch panel 2 will not affect the distribution of the vibration amount of the touch panel 2.

In some embodiments, the mounting member 1 can be made of stainless steel, so that the performance of the mounting member 1 itself will not be affected by the temperature. For example, the body 11, the side wall 13, and the cross arm 14 can all be made of stainless steel.

In some embodiments, as shown in FIG. 1, at least one lightening hole 111 is formed in the body 11 to reduce a weight of the body 11, thereby reducing the overall weight of the touch feedback device 100.

In some embodiments, the fastener can be a screw, a bolt, or a stud.

In order to solve the above technical problems, some embodiments of the present invention further provide an electronic device including the above-described touch feedback device 100. The electronic device can be a tablet computer, a notebook computer, or a car module.

The above illustrates only some embodiments of the present invention. It should be pointed out that for those of ordinary skill in the art, improvements can be made without departing from the inventive concept of the present invention, and all these improvements shall fall within a scope of protection of the present invention.

What is claimed is:

1. A touch feedback device, comprising a touch panel; a linear vibration motor arranged on the touch panel and being able to drive the touch panel to vibrate; a mounting member; and
a mounting base, wherein the mounting member comprises at least one fixing part and a body that is elastic, wherein the touch panel is fixed to the body, and the at least one fixing part is configured to fix the body to the mounting base, in such a manner the touch panel is limited to vibrate along any direction in a horizontal direction.

2. The touch feedback device as described in claim 1, wherein the mounting member further comprises at least one side wall connected to a side of the body, and the at least one fixing part is arranged at a side of the side wall away from the body.

3. The touch feedback device as described in claim 2, wherein the mounting member further comprises at least one cross arm, wherein the at least one cross arm is disposed at a side wall of the body, and the side wall is connected to the body through the at least one cross arm.

4. The touch feedback device as described in claim 3, further comprising a double-side adhesive layer, wherein the touch panel is fixed to at least one of the body or the at least one cross arm through the double-side adhesive layer.

5. The touch feedback device as described in claim 4, wherein the double-side adhesive layer comprises a primary adhesive part, wherein the primary adhesive part has a shape fitting a shape of the body in such a manner that the touch panel is fixed to the body through the primary adhesive part.

6. The touch feedback device as described in claim 5, wherein the double-side adhesive layer further comprises at least one secondary adhesive part, wherein the at least one secondary adhesive part is arranged at a side of the primary adhesive part, and the secondary adhesive part has a shape fitting a shape of the at least one cross arm in such a manner that the touch panel is fixed to the at least one cross arm through the secondary adhesive part.

7. The touch feedback device as described in claim 3, wherein the at least one cross arm comprises a plurality of the cross arms, wherein the plurality of cross arms is arranged at intervals along a length direction of the side wall.

8. The touch feedback device as described in claim 2, wherein the at least one side wall comprises two side walls respectively arranged at two opposite ends of the body, wherein each of the two side walls is connected to a side of the body away from the touch panel, and each of the two side walls is provided with the at least one fixing part.

9. The touch feedback device as described in claim 3, wherein the body, the at least one side wall, and the at least one cross arm are all made of stainless steel.

10. An electronic device, comprising a touch feedback device, wherein the touch feedback device comprises a touch panel; a linear vibration motor arranged on the touch panel and being able to drive the touch panel to vibrate; a mounting member; and a mounting base, wherein the mounting member comprises at least one fixing part and a body that is elastic, wherein the touch panel is fixed to the body, and the at least one fixing part is configured to fix the body to the mounting base, in such a manner the touch panel is limited to vibrate along any direction in a horizontal direction.
